(19) United States
(12) Patent Application Publication
(10) Pub. No.: US 2004/0254686 A1
(43) Pub. Date: Dec. 16, 2004

(54) Energy consumption prediction apparatus and energy consumption prediction method

(76) Inventors: Masaru Matsui, Souraku-gun (JP); Sachio Nagamitsu, Kyoto-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/854,251

(22) Filed: May 27, 2004

(30) Foreign Application Priority Data
May 28, 2003 (JP) 2003-151085

(51) Int. Cl. G05D 11/00

(52) U.S. Cl. 700/291

(57) ABSTRACT

The present invention prepares air-conditioner energy consumption as teacher data in the case three indices of solar radiation amount, heat conduction amount, and clearance area are respectively changed; performs interpolation calculations to the air-conditioner energy consumption using said three indices; and stores the energy consumption interpolation information into the air-conditioner energy consumption interpolation information storage unit (35). The air-conditioner energy consumption calculation unit (30) calculates, based on the actual use condition inputted to the use condition input unit (10), air-conditioner energy consumption using said three factors calculated by the air-conditioner load factor calculation unit (20) and energy consumption interpolation information stored in the air-conditioner energy consumption interpolation information storage unit (35).

### BACKGROUND OF THE INVENTION

(1) Field of the Invention

The present invention relates to an apparatus such as an air-conditioner that predicts energy consumption and air conditioning load and to a method thereof.

(2) Description of the Related Art

In general, a user who is going to install an air-conditioner in his/her house is more likely to concern about a running cost (electricity cost) as well as an initial cost (purchase cost) of the air-conditioner. In this case, there are mainly two methods for a manufacturer to provide a user information relating to the running cost.

The first method is a method of calculating an estimated running cost using COP (Coefficient of Performance) of an air-conditioner (Related Art 1). The second method is a method of predicting a running cost, using a simulation software, based on actual use conditions of a user such as a residential floor plan (e.g. refer to “The Society of Heating, Air-Conditioning and Sanitary Engineers of Japan Reports.” pp. 1149-1152, 1990. (Related Art 2)).

FIG. 1 is a block diagram showing a functional configuration of an energy consumption prediction apparatus 150 in the second related art. As shown in FIG. 1, the energy consumption prediction apparatus 150 comprises a use condition input unit 100, an air-conditioner energy consumption calculation unit 130 and an air-conditioner energy consumption display unit 140, the use condition input unit 100 receiving an input of actual use conditions about an air-conditioner, the air-conditioner energy consumption calculation unit 130 calculating an amount of energy consumption of an air-conditioner by performing an energy simulation based on CFD (Computational Fluid Dynamics), and the air-conditioner energy consumption display unit 140 presenting to a user information relating to the amount of energy consumption calculated by the air-conditioner energy consumption calculation unit 130. Furthermore, the use condition input unit 100 has a city information input unit 101, a life pattern information input unit 102, a window information input unit 103, an insolation shading information input unit 104, a building framework member information input unit 105, and an airtightness information input unit 106.

The city information input unit 101 receives information relating to a city where the house in which an air-conditioner is installed is located. The life pattern information input unit 102 receives information relating to a life pattern of a user who uses the air-conditioner. The window information input unit 103 receives information relating to a size of each window of the house and a direction to which said each window is facing. The insolation shading information input unit 104 receives, in the case where an insolation screen is installed, information relating to its insolation shading ability. The building framework member information input unit 105 receives information relating to an index that indicates an amount of heat which inflows or outflows depending on a difference of temperature between a wall, a window, a floor or a ceiling of the house, and the outside air. The airtightness information input unit 106 receives information relating to an airtightness performance of the house.

An air-conditioner energy consumption calculation unit 130 of the energy consumption prediction apparatus 150 receives the information relating to a city and the information relating to a life pattern from a user at the use condition input unit 100, executes the simulation program, and calculates the amount of energy consumption. The calculated amount of energy consumption is then displayed at the air-conditioner energy consumption display unit 140.

However, the first method does not consider actual use conditions such as a residential floor plan, various performances of the residence (e.g. heat insulation property, airtightness performance etc.), a location condition and a life pattern. Therefore, it cannot precisely predict a running cost in the case where a user actually uses an air-conditioner, even it can compare the amount of energy consumption among different air-conditioners.

On the other hand, the second method requires vast amounts of calculation time for the simulation calculation (several tens of seconds˜several minutes) even using a modern high efficient electronic computer. Therefore, it cannot immediately respond to a small specification change by a user such as a model change of an air-conditioner. That is, the usability is not good.

### SUMMARY OF THE INVENTION

Considering above mentioned problems, the present invention aims to provide an energy consumption prediction apparatus of an air conditioner and the like, the energy consumption prediction apparatus being able to provide an energy consumption prediction value precisely and promptly to arbitral air-conditioner use conditions.

To achieve the above objective, according to the present invention, the energy consumption prediction apparatus predicts an amount of energy to be consumed by an air-conditioner installed in a room and comprises: a use condition receiving unit operable to receive a use condition from a user for using the air-conditioner; a factor calculation unit operable to calculate the following three factors based on the received use condition: a first factor relating to an amount of insolation that enters said room; a second factor relating to an amount of heat conduction that is based on a difference of temperatures between the room and the outside of said room; and a third factor relating to natural ventilation between the room and the outside of said room; and a consumption amount calculation unit operable to calculate the amount of energy to be consumed by the air-conditioner based on the calculated three factors.

Accordingly, the amount of energy consumption is calculated based on factors that are solar radiation amount, heat conduction amount, clearance area largely affecting the amount of energy consumed by the air-conditioner. Therefore, a prediction value of energy consumption can be presented precisely and promptly.

In here, to achieve the above objective, the present invention can be realized as the energy consumption prediction apparatus based on the characteristic structural steps, and as a program including all those steps. Furthermore, the program is not only stored in a ROM and the like held in the energy consumption prediction apparatus but also can be distributed via recording medium such as CD-ROM and a transmission medium such as a communication network As above described, the energy consumption prediction apparatus according to the present invention specifies three factors of the solar radiation amount, the heat conduction amount, and the clearance area that largely affecting the amount of energy consumed by the air-conditioner based on information received from a user and calculates the amount of energy consumed by the air conditioner using a data interpolation method such as a neural network. Therefore, a prediction value of energy consumption can be presented promptly and precisely to the use conditions of the arbitral air-conditioner.

As further information about technical background to this application, the disclosure of Japanese Patent Application No. 2003-151085 filed on May 28, 2003 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a functional configuration of an energy consumption prediction apparatus according to the second related art.

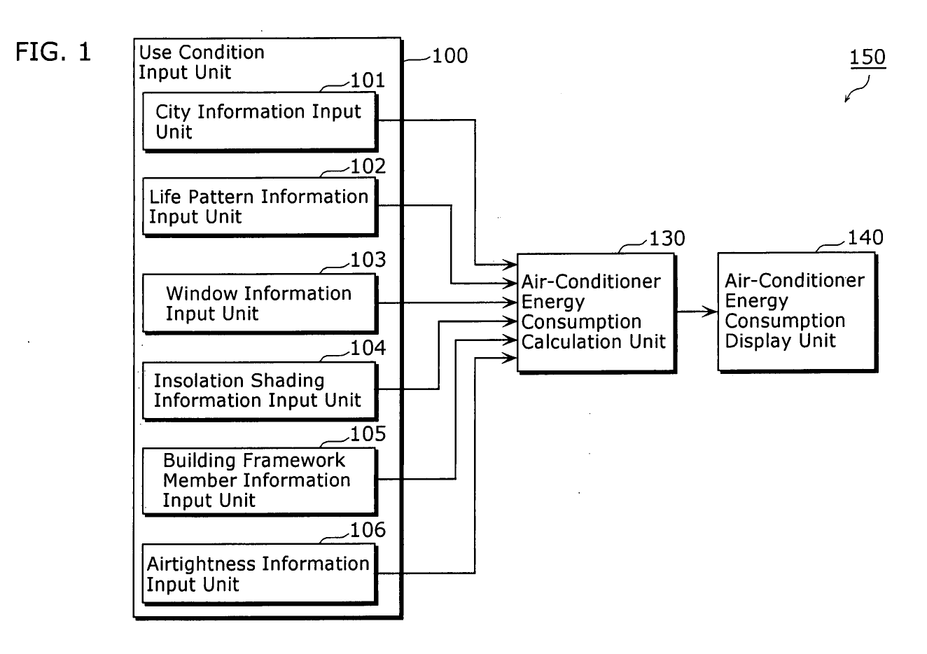

FIG. 2 is a diagram showing a summary of functions of the energy consumption prediction apparatus according to the first embodiment.

FIG. 3 is a block diagram showing a functional configuration of an energy consumption prediction apparatus according to the first embodiment.

FIG. 4 is a diagram showing an example of data for a solar radiation amount index held in a solar radiation amount calculation unit.

FIG. 5 is a diagram showing an example of data for a heat conduction amount index held in a heat conduction amount calculation unit.

FIG. 6 is a diagram showing an example of data for a clearance area index held in a clearance area calculation unit.

FIG. 7 is a diagram showing a structural example of a neural network according to the first embodiment.

FIG. 8 is a flowchart showing a flow of processes of generating a weight file.

FIG. 9 is an example of a directory structure showing a generation environment for the weight file.

FIG. 10 is a flowchart showing a flow of processes at the energy consumption prediction apparatus according to the first embodiment.

FIG. 11 is a display example at an air-conditioner energy consumption display unit according to the first embodiment.

FIG. 12 is a block diagram showing a functional configuration of an energy consumption prediction apparatus according to the second embodiment.

FIG. 13 is a diagram for explaining a brief of clearance calculations in an air-conditioner energy consumption calculation unit according to the second embodiment.

FIG. 14 is a display example at an air-conditioner energy consumption display unit according to the second embodiment.

### DESCRIPTION OF THE PREFERRED EMBODIMENT(S)

The following explains in detail about embodiments according to the present invention with references to figures.

### First Embodiment

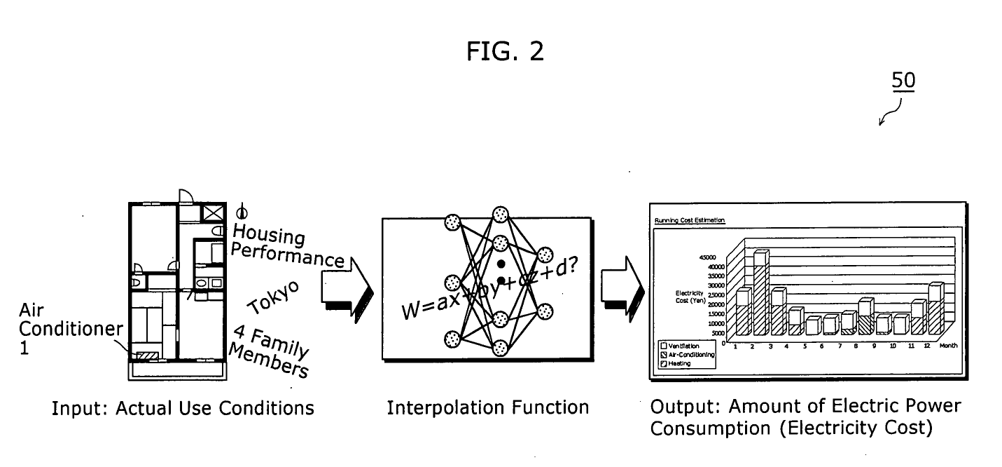

FIG. 2 is a diagram showing a summary of functions of the energy consumption prediction apparatus 50 according to the present embodiment. As shown in FIG. 2, the energy consumption prediction apparatus 50 promptly and precisely predicts an amount of energy consumption (also called as “the amount of consumption electricity”) of various air-conditioners to be installed based on: the conditions relating to air-conditioning performances such as heat insulating effectiveness, a floor plan of a room (or a house), an address of the house, a family structure and the like in which an air-conditioner is installed; the interpolation function being calculated previously with a method such as a neutral network; and the like.

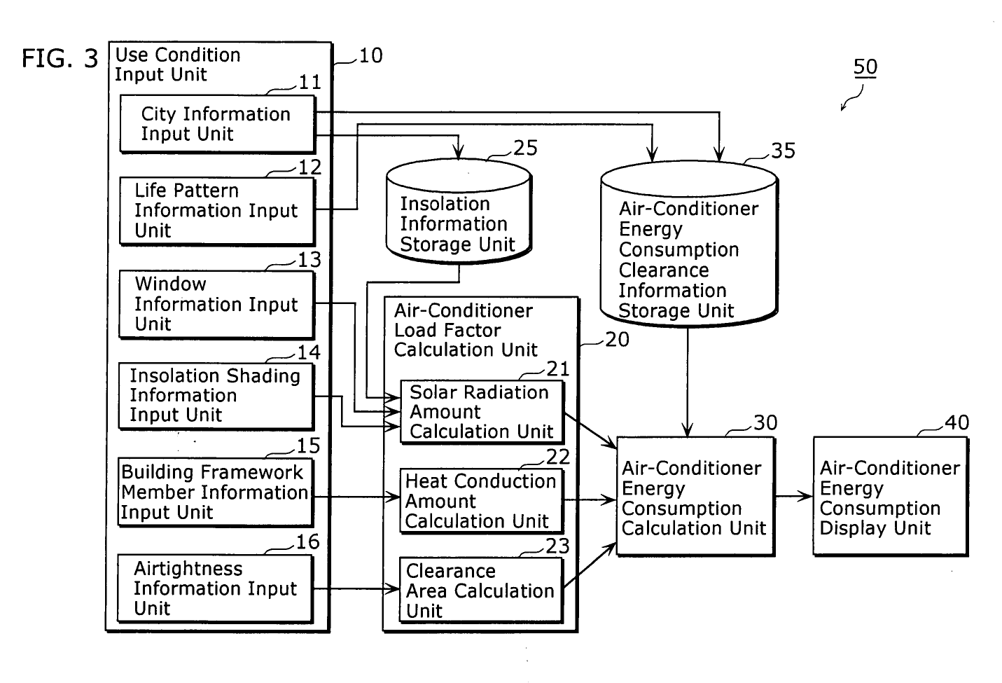

FIG. 3 is a block diagram showing a functional configuration of the energy consumption prediction apparatus 50 according to the present embodiment. The energy consumption prediction apparatus 50 is formed of following units: a use condition input unit 10 that receives an input of actual use conditions for the air conditioner 1 to be predicted the amount of its energy consumption; an air-conditioner load factor calculation unit 20 that calculates a factor (also called as “index”) affecting a fluctuation of the amount of energy consumed by the air-conditioner 1 from the actual use conditions received via the use condition input unit 10; an insolation information storing unit 25 that stores insolation information in association with big cities in a country; an air-conditioner energy consumption calculation unit 30 that calculates the amount of energy consumption of the air-conditioner 1 with the interpolation function calculated using the neural network and the like; an air-conditioner energy consumption interpolation information storing unit 35 that stores energy consumption interpolation information used for the calculation at the air-conditioner energy consumption calculation unit 30; and an air-conditioner energy consumption display unit 40 that displays information relating to the amount of energy consumption calculated at the air-conditioner energy consumption calculation unit 30.

Furthermore, the use condition input unit 10 has a city information input unit 11, a life pattern information input unit 12, a window information input unit 13, an insolation shading information input unit 14, a building framework member information input unit 15 and an airtightness information input unit 16.

The city information input unit 11 receives, from a user, a city name (e.g. Tokyo, Osaka, Sapporo, etc.) where a house, in which an air-conditioner is installed, is located and the like, and reports the received information to the insolation information storage unit 25 and the air-conditioner energy consumption interpolation information storage unit 35. It is desirable for the city name to register a plurality of major city names where has similar climate conditions in a country.

The life pattern information input unit 12 receives information relating to a life pattern of a user of the air-conditioner 1. The information relating to a life pattern include, other than the number of family members, information relating to controlling a use of the air-conditioner such as information about whether or not a user uses the air-conditioner for 24 hours, and whether or not an absence and a presence of a user can be controlled.

The window information input unit 13, the insolation shading information input unit 14, the building framework member information input unit 15 and the airtightness information input unit 16 receive, from a user, information relating to air-conditioning such as specifications of a room (or the house) in which an air-conditioner 1 is installed and a performance to a heating load.

The window information input unit 13 receives information relating to windows such as a size of a window and information about to which direction the window is facing. The insolation shading information input unit 14 receives, in the case where something to block sunlight such as curtain, blind, and paper screen is installed to a window, information about its insolation shading ability. In this case, insolation shading information may be altered for each window. The building framework member information 15 receives an index (also called as a “factor”) indicating an amount of inflow and outflow of heat according to a difference of temperature between a part such as wall, window, floor or ceiling and the outside air. The heat conductivity of each part is desirable for this index. The airtightness information input unit 16 receives information relating to airtightness of a house. An equivalent clearance area (that is, a clearance area per unit gross floor area) is desirable for the information relating to the airtightness.

The insolation information storage unit 25 stores information relating to the amount of insolation for each city (e.g. the amount of insolation entering from a window of each direction (East, West, South and North) for a unit area per day). The information can be either a measured value or a theoretical value.

Next explains about an air-conditioner load factor calculation unit 20 which has a distinguishing functional structure according to the present invention. The air-conditioner load factor calculation unit 20, as shown in FIG. 3, has a solar radiation amount calculation unit 21, a heat conduction amount calculation unit 22 and a clearance area calculation unit 23.

The solar radiation amount calculation unit 21 calculates an index (hereafter referred to as “solar radiation amount index”) which shows a degree of influence by solar radiation heat entering a room (or a house) in which an air-conditioner 1 is installed. When the index is calculated, the information relating to the amount of insulation heat corresponding to a city name and the like that are inputted at the city information input unit is used, the information being stored in the insolation information storage unit 25. In this case, the solar radiation amount index is defined as follows:

$$\begin{matrix}Solar Radiation Amount Index = Σ ( window area \times insolation \\ shading coefficient \times amount of \\ insolation directly entering from \\ the direction to which a window \\ is facing \text{/} day \cdot unit area )\end{matrix} \qquad ( 1 )$$

As shown in the (1) equation, the solar radiation amount index calculates inside of ( ) in the (1) equation for all windows and calculates the total.

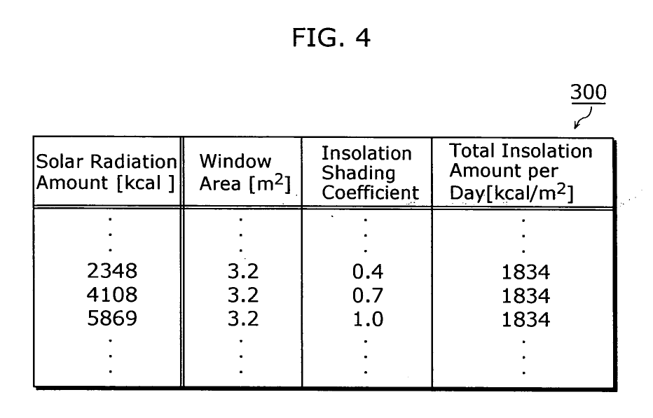

FIG. 4 is a diagram showing an example of three patterns of the solar radiation amount index calculated in the solar radiation amount calculation unit 21. For convenience, FIG. 4 shows an example of a case where there is one window. As above described, a sum total of the said equation is calculated for all windows in a room (or a house) in which an air-conditioner 1 is installed.

The heat conduction amount calculation unit 22 calculates an index showing a degree of heat inflow and outflow by heat conduction between indoor and outdoor (hereafter referred to as “heat conduction amount index”) in a whole room (or in a whole house) through a wall, a window, a floor or a ceiling. The heat conduction amount index is defined as following equation:

$$\begin{matrix}Heat Conduction \\ Amount Index\end{matrix} = \sum ( heat transfer coefficient \times area ) \qquad ( 2 )$$

In this case, the sum total of the equation is calculated for each area (e.g. wall, window, floor or ceiling).

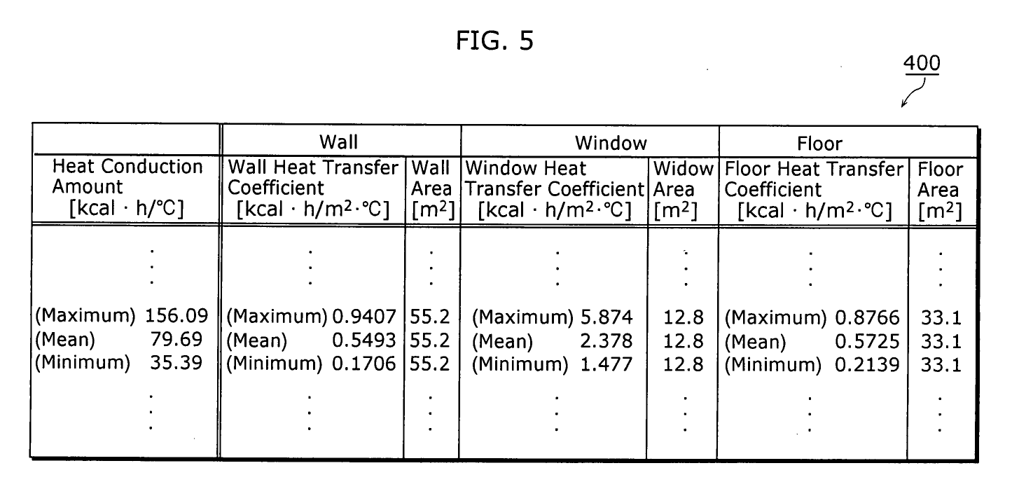

FIG. 5 is a diagram showing an example of three patterns of the heat conduction amount index calculated in the heat conduction amount calculation unit 22.

The clearance area calculation unit 23 calculates an index (hereafter referred to as “clearance area index”) indicating a degree of natural ventilation in a whole room (or in a whole house) through clearances. The clearance area index is defined as following equation:

$$\begin{matrix}Clearance Area Index = equivalent clearance area \times floor area of a \\ room in which air \text{-} conditioner is installed\end{matrix} \qquad ( 3 )$$

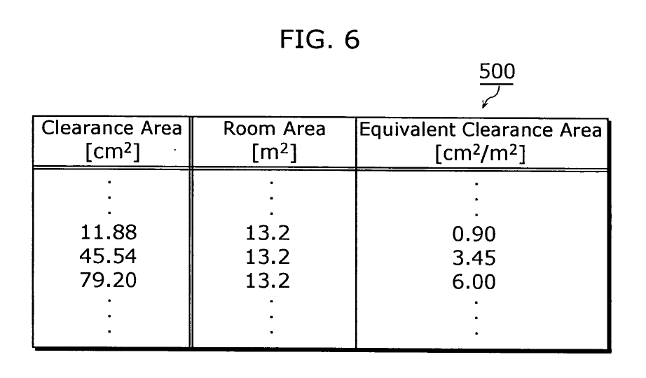

FIG. 6 is a diagram showing an example of three patterns of the clearance area index calculated in the clearance area calculation unit 23.

Here explains about the three indices according to this embodiment.

The three indices of the solar radiation amount, the heat conduction amount and the clearance area are significant factors of affecting the amount of air conditioning loads. Following five elements are main factors of influencing the indoor air conditioning load in the case where an air-conditioner or a heater is used (e.g. refer. to Junpei Obara. “Air-Conditioning for One Million People.” Ohmsha.).

(1) Solar Radiation Heat

The solar radiation heat is the heat which enters indoor as direct sunlight enters through a window. It becomes a significant factor of increasing air-conditioning loads when an air-conditioner is used. It changes depending on the amount of insolation, the size of a window and the insolation shading coefficient.

(2) Heat Conduction by Temperature Difference

The heat conduction is the heat which inflows or outflows indoor from a wall, a window, a floor and ceiling when there is a difference of temperatures between indoor and outdoor. It needs to be considered in both cases of using an air-conditioner and a heater. The heat is affected by heat transfer coefficient and the size (width) of each part.

(3) Indoor Generation Heat

The indoor generation heat is the heat which is generated in the case where there are electronic equipments and gas appliances in a room. It becomes a factor of increasing air-conditioning loads when an air-conditioner is used.

(4) Entering Outside Air

A factor caused by outside air entering from clearances of a room (or a house), the factor influencing air-conditioning loads. While it is not particularly considered at the time of using an air-conditioner, it cannot be ignored as a factor of increasing air-conditioning loads at the time of using a heater. It is affected by the airtightness of a house.

(5) Intaking Outside Air

A factor caused by outside air taken in the case where an air-conditioner with a ventilator function ventilates air, the factor influencing air conditioning loads.

The solar radiation amount, the heat conduction amount, the clearance area are exactly the factors of (1), (2), and (4). The factor (3) can consider typical heating conditions in the case where energy consumption interpolation information stored in the air-conditioner energy consumption interpolation information storage unit 35 is generated. The factor (5) can be considered similarly in the case where the energy consumption interpolation information is generated since the factor (5) results from the specification and performance of the air-conditioner 1. Accordingly, it becomes possible to generate an interpolation function and the like using the following three factors of the solar radiation amount, the heat conduction amount and the clearance area, the interpolation function being used in the case where the amount of energy consumption by an air-conditioner 1 is calculated.

The air-conditioner energy consumption interpolation information storage unit 35 is a storing apparatus, such as RAM, for storing energy consumption interpolation information in accordance with a calculation method in the air-conditioner energy consumption calculation unit 30. For example, the air-conditioner energy consumption interpolation information storage unit 35 stores a file (weight file) which stored weight between neurons in the case where an interpolation function is led out using a neural network (e.g. a back propagation method that is also referred to as “BP”) in the air-conditioner energy consumption calculation unit 30. Specifically, the weight file is a file in which information indicating “weight” that is a learning result by a neural network is stored. It defines the “weight” which includes all combinations of a city name inputted at the city information input unit 11 and a life pattern such as the number of family members inputted at the life pattern information input unit 12. Thus, the city name and the life pattern are determined so that a single weight file is specified.

Further, teacher data used for learning by a neural network are indices calculated at the solar radiation amount calculation unit 21, the heat conduction amount calculation unit 22 and the clearance area calculation unit 23, and the amount of energy to be consumed by an air-conditioner 1 that corresponds to each index. The interpolation function (weight file) is determined based on the teacher data.

The following explains more specifically about the weight file used by the back propagation method.

The weight file is prepared for each model (e.g. three models of 4.0 kW model, 5.0 kW model and 6.4 kW model), control pattern (e.g. three types of standard family 24 hours control, standard family presence/absence control and DINKS family presence/absence control), city (twelve cities of Akita, Sendai, Niigata, Matsumoto, Tokyo, Nagoya, Toyama, Osaka, Takamatsu, Hiroshima, Fukuoka and Kagoshima). Therefore, there are 108(=3 ×3×12) variations of the weight file. Additionally, one weight file stores weight information for twelve months.

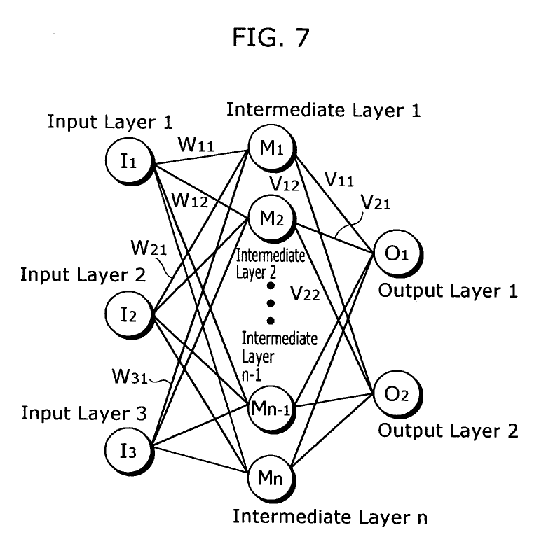

FIG. 7 is a diagram showing a structural example of a neural network according to the present embodiment. As shown in FIG. 7, inputs in the neural network are the solar radiation amount index, the heat conduction amount index and the clearance area index, and outputs are the heat load and the energy consumption amount. Furthermore, in FIG. 7, Win (i, n: natural number) is a weight between the input layer and the intermediate layer, and Vno (n, o: natural number) is a weight between the intermediate layer and the output layer. Note that, in FIG. 7, an offset can be given in the intermediate layer or the output layer.

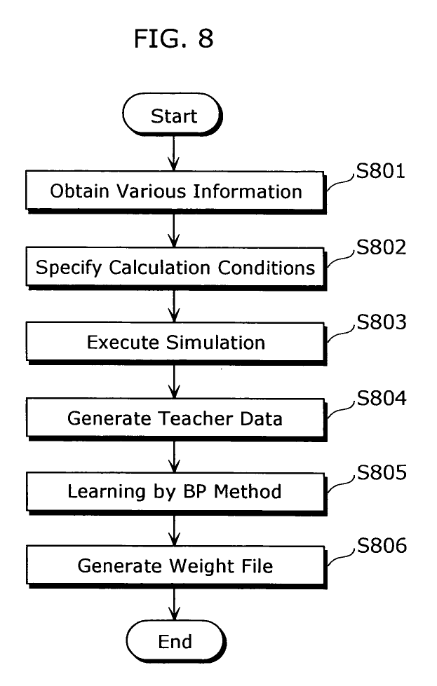

Next, a process of generating the weight file is explained. FIG. 8 is a flowchart showing a flow of the process of generating the weight file.

First, a program (hereafter referred to as “control program”) stored in a total control unit (not shown in a diagram) that controls the energy consumption prediction apparatus 50 as a whole, stores the city information and the life pattern information (S801), specifies a calculation condition that is needed to execute a simulation calculation and generates a file showing the calculation condition (S802).

Second, the control program executes the simulation calculation and calculates the amount of energy consumption (S803).

After that, the teacher data generation program stored in the total control unit generates teacher data for leaning by a BP method, based on the amount of energy consumption that is a result of the simulation calculation (S804). The heat load and the amount of energy consumption per day for each month are normalized and stored in the teacher data. In this case, the normalization value is calculated as following equation (4):

$$\begin{matrix}Normalization Value = ( simulation calculated value - \\ minimum value ) / ( maximum value - \\ minimum value )\end{matrix} \qquad ( 4 )$$

Lastly, the weight file generation program stored in the total control unit performs learning by the BP method (S805) using the teacher data and generates the weight file (S806).

In here, each value inputted in the input layer of the teacher data are the predetermined minimum, mean and maximum values. For example, the solar radiation amount index has three indices of the minimum value, the mean value and the maximum value; the heat conduction amount index has four indices of the minimum value, two mean values, and the maximum value; and the clearance area index has three indices of the minimum value, the mean value and the maximum value. The reason of why the heat conduction amount index has two mean values is because that a change of the amount of energy consumption by the heat conduction amount index is large.

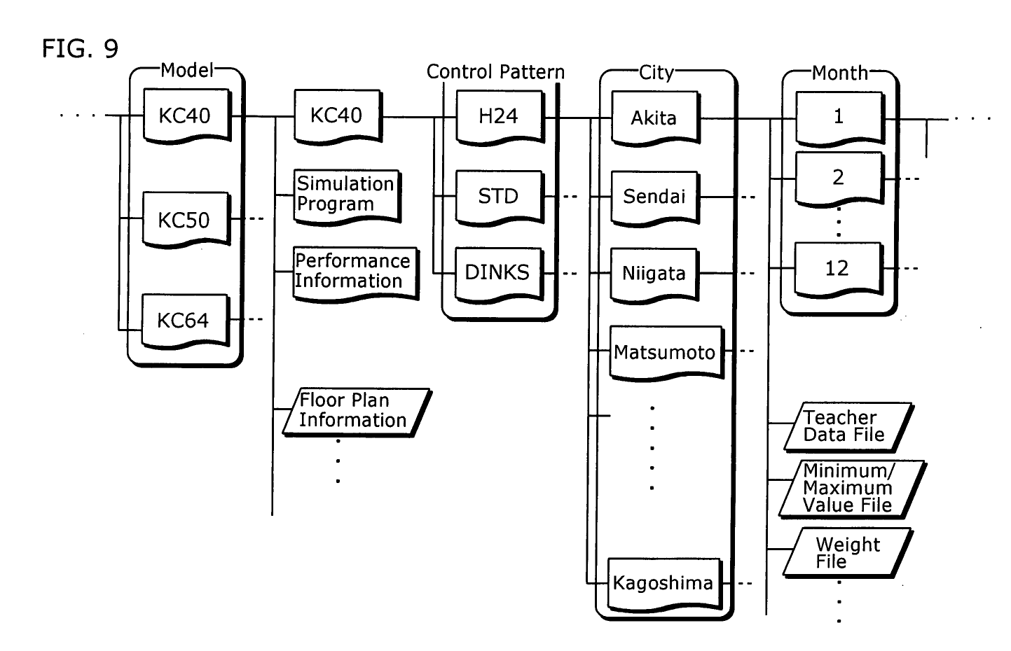

FIG. 9 is an example of a directory structure that shows a generation environment of the weight file. As shown in FIG. 9, the teacher data file, the weight file and the like are stored under the directory of city.

Here, data indicating the amount of energy consumed by the air-conditioner 1 can be measured data obtained by experiments or data obtained by an energy simulation. The time scale of data indicating the amount of energy consumption of the air-conditioner 1 can be any one of a year, a month, a day and an hour. The time scale is set as same as that of information context to be presented to a user at the air-conditioner energy consumption display unit 40 or smaller time scale. The plurality of teacher data obtained as described is set by providing information relating to housing as an input and the air-conditioner energy consumption amount as an output and a weight is learned in a neural network. In the case where the learning is performed in a neural network, the time scale of the amount of energy consumed by an air-conditioner 1 can be the same time scale as that of information presented to a user in the air-conditioner energy consumption display unit 40.

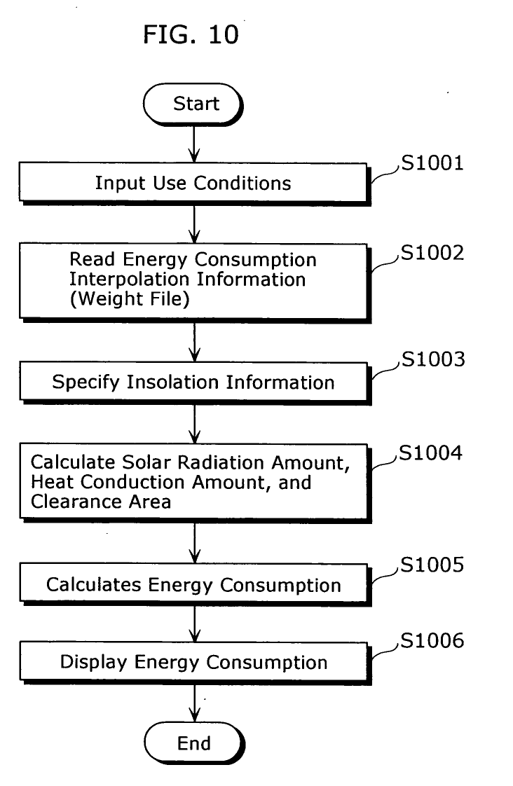

Next, operations of an energy consumption prediction apparatus 50 in the present embodiment are explained. FIG. 10 is a flowchart indicating a flow of processes in the energy consumption prediction apparatus 50.

First, the use condition input unit 10 receives information from a user, the information relating to a room and a house in which an air-conditioner is installed (S1001).

Next, responding to information set at the city information input unit 11, a life pattern information input unit 12, the air-conditioner energy consumption interpolation information storage unit 35 reads out energy consumption interpolation information such as a neural network weight file corresponding to said set information (S1002) and outputs the readout information to the air-conditioner energy consumption calculation unit 30.

On the other hand, the insolation information storage unit 25 receives city information from the city information input unit 11, specifies the insolation information of said city (S1003), and outputs the specified information to the solar radiation amount calculation unit 21.

Accordingly, the air-conditioner load factor calculation unit 20 receives information inputted from the use condition input unit 10 and insolation information from the insolation information storage unit 25, calculates said three indices at the solar radiation amount calculation unit 21, a heat conduction amount calculation unit 22 and the clearance area calculation unit 23 (S1004), and outputs the air-conditioner energy consumption calculation unit 30.

Then, the air-conditioner energy consumption calculation unit 30 calculates the amount of energy consumption by an air-conditioner using energy consumption interpolation information such as a weight file obtained from the air-conditioner energy consumption interpolation information storage unit 35 (S1005).

Lastly, the air-conditioner energy consumption display unit 40 receives the amount of energy consumption by the air-conditioner calculated by the air-conditioner energy consumption calculation unit 30 and submits information relating to the calculated amount of energy consumption to a user by means of screen and sound (S1006).

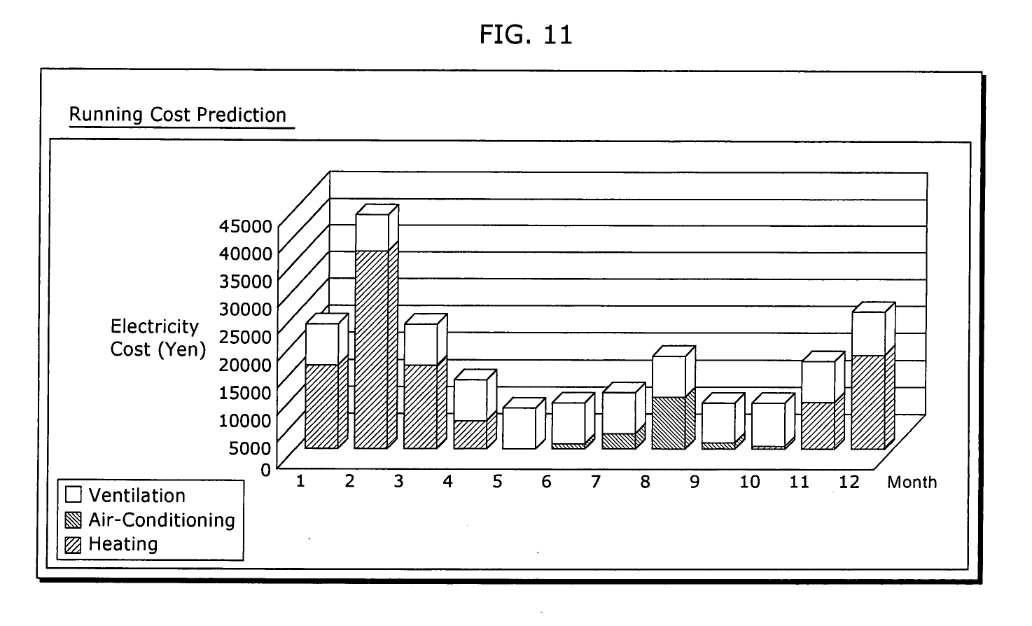

FIG. 11 is a display example relating to an amount of energy consumption by the air-conditioner 1 displayed at the air-conditioner energy consumption display unit 40. In the case of FIG. 11, a prediction example of monthly electricity cost used for air-conditioning, heating, and ventilating is shown.

As above described, the energy consumption prediction apparatus according to the present embodiment (1) inputs factors which largely affects the amount of energy consumption by an air-conditioner such as the solar radiation amount, the heat conduction amount and the clearance area and (2) calculates the amount of energy consumption using a data interpolation method such as neural network. Therefore, a prediction value of the amount of energy consumption can be presented precisely and promptly to the use conditions for an air-conditioner of a user.

### Second Embodiment

The first embodiment explains about an embodiment for predicting the amount of energy consumption by an air-conditioner using a data interpolation method such as a neural network based on three factors that largely influences the amount of energy consumption of the air-conditioner called the solar radiation amount, the heat conduction amount, and the clearance area. On the other hand, this embodiment explains about an embodiment that calculates a prediction value of the amount of energy consumption of an air-conditioner using the heat load calculated based on said three factors.

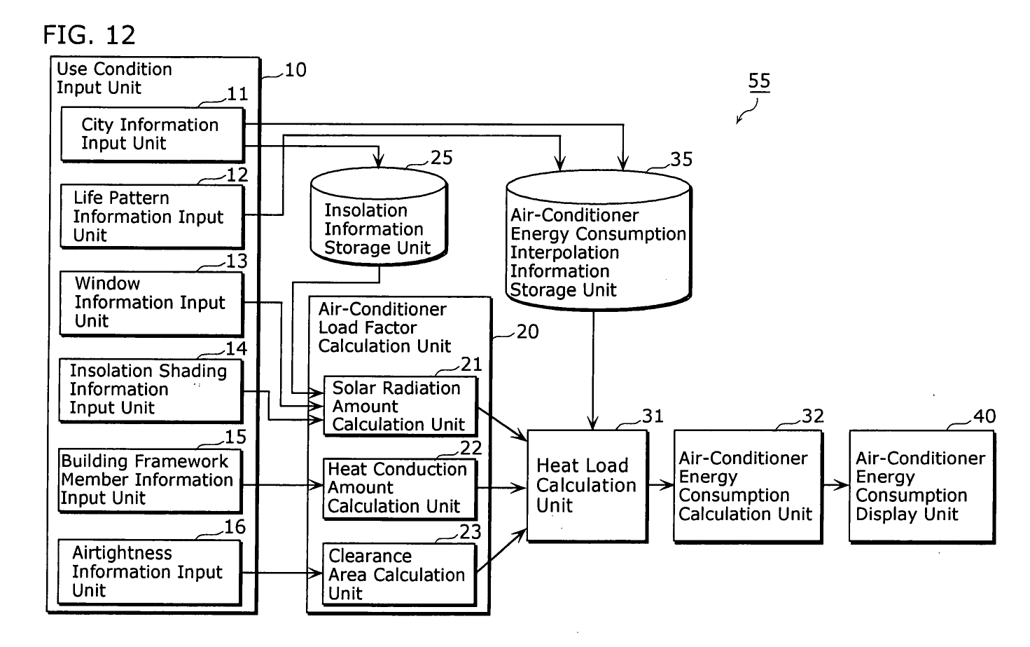

FIG. 12 is a block diagram showing a functional configuration of an energy consumption prediction apparatus 55 according to the present embodiment. As shown in FIG. 12, the energy consumption prediction apparatus 55 has a heat load calculation unit 31 and an air-conditioner energy consumption calculation unit 32 replacing to the air-conditioner energy consumption calculation unit 30 of the energy consumption prediction apparatus in the first embodiment. In the following, the same components in the functional configuration as that of the energy consumption prediction apparatus 50 in the first embodiment are put with the same marks and the explanations about the components are omitted.

The heat load calculation unit 31 calculates heat loads of a room (or a house) in which an air-conditioner is installed based on the solar radiation amount index, the heat conduction amount index, and the clearance area index that are explained in the first embodiment.

The air-conditioner energy consumption calculation unit 32 calculates the amount of energy consumption by an air-conditioner 1 with an interpolation method such as a neural network, based on the heat load calculated in the heat load calculation unit 31 and the interpolation information stored in the air-conditioner energy consumption interpolation information storage unit 35.

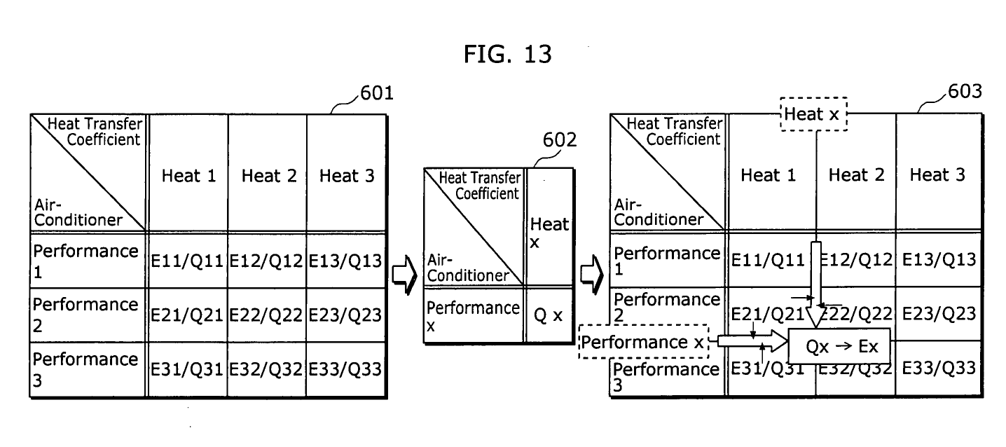

FIG. 13 is a diagram showing a brief of calculations in the air-conditioner energy consumption calculation unit 32. In FIG. 13, a maximum heat load value (Qx) corresponding to a heat transfer coefficient (heat x) and a performance of an air-conditioner (performance x) is calculated at first, then the amount of energy consumption (Ex) is calculated by interpolating an existing heat load calculation value (Qnm) to the Qx.

Here, FIG. 13 is a diagram showing simplified interpolation calculations in the air-conditioner energy consumption calculation unit 30. In fact, multidimensional (considering the solar radiation amount index, the heat conduction amount index, and the clearance area index) interpolation calculations are performed.

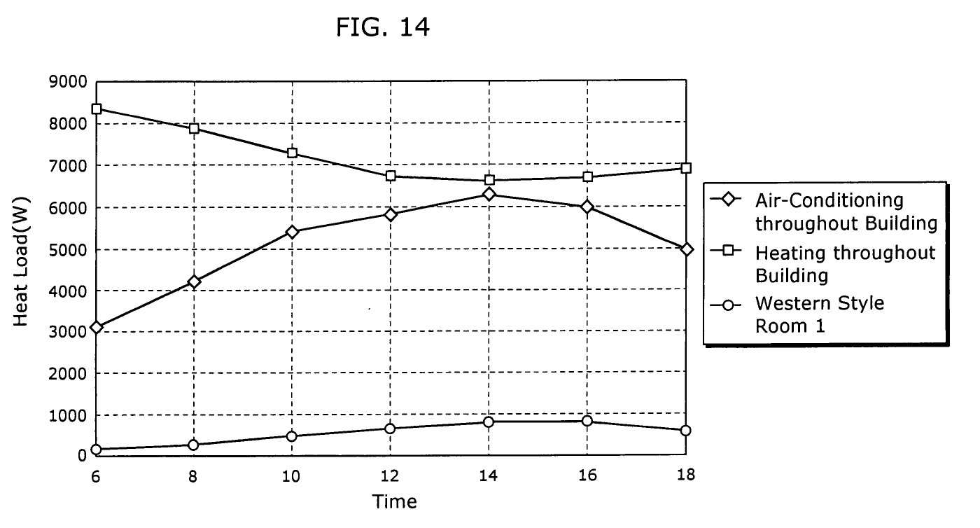

FIG. 14 is a display example at the air-conditioner energy consumption display unit of the energy consumption prediction apparatus 55 in the second embodiment. FIG. 14 shows prediction results of heat loads from 6 o'clock to 18 o'clock in the case where an air-conditioner 1 is installed in a room (or a house) to be predicted.

Note that, while the present invention is explained with references to figures according to the embodiment 1 and 2, the present invention does not intend to limit its effects to them.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

Industrial Applicability

An energy consumption prediction apparatus according to the present invention can be applied to a general personal computer, PDA and the like.

1. An energy consumption prediction apparatus that predicts an amount of energy to be consumed by an air-conditioner installed in a room, comprising:
a use condition receiving unit operable to receive a use condition from a user for using the air-conditioner;
a factor calculation unit operable to calculate the following three factors based on the received use condition: a first factor relating to an amount of insolation that enters said room; a second factor relating to an amount of heat conduction that is based on a difference of temperatures between the room and the outside of said room; and a third factor relating to natural ventilation between the room and the outside of said room; and
a consumption amount calculation unit operable to calculate the amount of energy to be consumed by the air-conditioner based on the calculated three factors.

2. The energy consumption prediction apparatus according to claim 1, further comprising a heat load calculation unit operable to calculate heat load based on the calculated three factors,
wherein the consumption amount calculation unit calculates said amount of energy consumption based on the calculated heat load.

3. The energy consumption prediction apparatus according to claim 1, further comprising an interpolation function generation unit operable to generate an interpolation function based on the previously specified use condition and an amount of energy consumption corresponding to said use condition,
wherein the consumption amount calculation unit calculates said energy consumption by substituting the calculated three factors into the interpolation function.

4. The energy consumption prediction apparatus according to claim 3,
wherein the interpolation function generation unit generates the interpolation function using a neural network by use of the use condition and the corresponding amount of the energy consumption as teacher data.

5. An energy consumption prediction method that predicts an amount of energy to be consumed by an air-conditioner installed in a room, comprising:
a use condition receiving step of receiving a use condition from a user for using the air-conditioner;
a factor calculation step of calculating the following three factors based on the received use condition: a first factor relating to an amount of insolation that enters the room; a second factor relating to an amount of heat conduction that is based on a difference of temperatures between the room and the outside of said room; and a third factor relating to natural ventilation between the room and the outside of said room; and
a consumption amount calculation step of calculating the amount of energy to be consumed by the air conditioner based on the calculated three factors.

6. A program for an energy consumption prediction apparatus that predicts an amount of energy to be consumed by an air-conditioner installed in a room, the program causing a computer to execute the following steps:
a use condition receiving step of receiving a use condition from a user for using the air-conditioner;
a factor calculation step of calculating the following three factors based on the received use condition: a first factor relating to an amount of insolation that enters the room; a second factor relating to an amount of heat conduction that is based on a difference of temperatures between the room and the outside of said room; and a third factor relating to natural ventilation between the room and the outside of said room; and
a consumption amount calculation step of calculating the amount of energy to be consumed by the air-conditioner based on the calculated three factors.

7. The energy consumption prediction apparatus according to claim 2, further comprising an interpolation function generation unit operable to generate an interpolation function based on the previously specified use condition and an amount of energy consumption corresponding to said use condition,
wherein the consumption amount calculation unit calculates said energy consumption by substituting the calculated three factors into the interpolation function.
